(19) United States
(12) Patent Application Publication
(10) Pub. No.: US 2013/0061164 A1
(43) Pub. Date: Mar. 7, 2013

(54) METHOD AND DEVICE FOR USING SUPER TASKBAR TO CONTROL INSTANT MESSAGING APPLICATION

(71) Applicant: TENCENT TECHNOLOGY (SHENZHEN) COMPA, Shenzhen (CN)

(72) Inventors: YUEWEI CHEN, Shenzhen (CN); Pu Wang, Shenzhen (CN); Yuedong Weng, Shenzhen (CN)

(73) Assignee: TENCENT TECHNOLOGY (SHENZHEN) COMPANY LIMITED, Shenzhen (CN)

(21) Appl. No.: 13/664,303

(22) Filed: Oct. 30, 2012

Related U.S. Application Data
(63) Continuation of application No. PCT/CN2011/071049, filed on Feb. 17, 2011.

(30) Foreign Application Priority Data
Apr. 30, 2010 (CN) 20101060438.8

(51) Int. Cl. G06F 3/048

(52) U.S. Cl. 715/779

(57) ABSTRACT

The present invention discloses a method for using a super taskbar to control instant messaging (IM) application, comprising: creating a virtual window corresponding to a main panel of the IM application; monitoring a window message in a window process of the virtual window; and executing a super taskbar operation according to the detected window message while monitoring the window message. The present invention is capable of creating a virtual window corresponding to a main panel of IM application, monitoring a window message in a window process of the virtual window, and executing a super taskbar operation according to the detected window message while monitoring the window message, so that the IM software supports the super taskbar, that is, the running state of the IM software is controlled by using the super taskbar, thus greatly improving a user's experience in using the IM application.

### CROSS-REFERENCE TO RELATED APPLICATIONS

This application is a continuation of International Application No. PCT/CN2011/071049, filed on Feb. 17, 2011, which claims the priority benefit of China Patent Application No. 201010160438.8, filed on Apr. 30, 2010. The contents of the above identified applications are incorporated herein by reference in their entirety.

### FIELD OF THE TECHNOLOGY

The present invention relates to the communication field and, in particular, to a method and device for using a super taskbar to control instant messaging (IM) software application.

### BACKGROUND

Windows 7 is a new-generation operating system launched by Microsoft Corporation. The new features provided by Windows 7 and, especially, the Windows 7 taskbar, are receiving more and more attention. The Windows 7 taskbar supports the program-defined window thumbnails, thumbnail toolbar, window live preview, taskbar button icon, taskbar overlay icon, and jump list, so that running programs can be controlled by using the taskbar. The window thumbnail refers to a thumbnail of a window that pops up when the mouse pointer hovers over a taskbar button. The thumbnail toolbar refers to a program-defined toolbar on the window thumbnail. The window live preview refers to a window live preview that pops up when the mouse pointer hovers over the window thumbnail, and is equal to the corresponding window in size. Because of the powerful functions of the Windows 7 taskbar, a toolbar having such functions in the prior art is referred to as a super taskbar.

The IM (Instant Messaging) networking tool, as it develops constantly, has become an indispensable software tool for network users. The IM tool can implement instant communication over the Internet by using a point-to-point technology, which also allows multiple terminals to participate in the same session.

With respect to the IM tool, if IM software may be controlled by using the super taskbar, user experience can be greatly improved. However, the prior art does not provide a technical solution for using the super taskbar to control IM software.

### SUMMARY

One aspect of the present invention provides a method for using a super taskbar to control IM software, so that the IM software is effectively controlled by using the super taskbar.

The method for using a super taskbar to control IM software according to an embodiment of the present invention comprises: creating a virtual window corresponding to a main panel of the IM software; monitoring a window message in a window process of the virtual window; and executing a super taskbar operation according to the detected window message while monitoring the window message.

Another aspect of the present invention provides a device for using a super taskbar to control IM software, wherein the device comprises: a memory, configured to store instructions; and a processor, coupled with the memory, configured to execute the instructions stored in the memory, and further configured to: create a virtual window corresponding to a main panel of the IM software; monitor a window message in a window process of the virtual window; and execute a super taskbar operation according to the detected window message while monitoring the window message.

Still another aspect of the present invention provides a machine-readable medium storing an instruction set, wherein, when the instruction set is executed, the machine is enabled to execute the method for using a super taskbar to control IM software according to an embodiment of the present invention.

Compared with the prior art, embodiments of the present invention are capable of creating a virtual window corresponding to a main panel of IM software, monitoring a window message in a window process of the virtual window, and executing a super taskbar operation according to the detected window message while monitoring the window message, so that the IM software supports the super taskbar, that is, the running state of the IM software is controlled by using the super taskbar, thus greatly improving a user's experience in using the IM software.

### BRIEF DESCRIPTION OF THE DRAWINGS

FIG. 1 is a schematic diagram of a method for using a super taskbar to control IM software according to a first embodiment of the present invention;

FIG. 2 is a schematic diagram of a technical hierarchical architecture of IM software according to a second embodiment of the present invention;

FIG. 3 is a schematic diagram of using a virtual window to control the representation of a main panel on a taskbar according to the second embodiment of the present invention;

FIG. 4 is a schematic diagram of a window thumbnail when taskbar buttons are combined according to the second embodiment of the present invention;

FIG. 5 is a schematic diagram of a window thumbnail when taskbar buttons are not combined according to the second embodiment of the present invention;

FIG. 6 is a schematic diagram of a process of creating a thumbnail of a main panel when taskbar buttons are not combined according to the second embodiment of the present invention;

FIG. 7 is a schematic diagram of a thumbnail toolbar according to the second embodiment of the present invention;

FIG. 8 is a schematic diagram of a taskbar button icon according to the second embodiment of the present invention;

FIG. 9 is a schematic diagram of a taskbar overlay icon according to the second embodiment of the present invention;

FIGS. 10 to 12 are schematic diagrams of icons of a jump list according to the second embodiment of the present invention;

FIG. 13 is a schematic diagram of a process of executing a shortcut according to the second embodiment of the present invention;

FIG. 14 is a schematic structural diagram of a device for using a super taskbar to control IM software according to a third embodiment of the present invention; and

FIG. 15 is a schematic structural diagram of an operation executing unit in the device for using a super taskbar to control IM software according to the third embodiment of the present invention.

### DETAILED DESCRIPTION

The specific embodiments of the present invention are hereinafter described in detail with reference to accompanying drawings.

The first embodiment of the present invention provides a method for using a super taskbar to control IM software. As shown in FIG. 1, the method comprises:

Step 101: create a virtual window corresponding to a main panel of IM software;

Step 102: monitor a window message in a window process of the virtual window; and

Step 103: execute a super taskbar operation according to the detected window message while monitoring the window message.

In embodiments of the present invention, the window process specifically refers to a window callback function. When the window size changes, or the mouse pointer hovers in the window, or the mouse button is pressed in the window, or any other action occurs, the system notifies the application of the actions through the window callback function, namely, the window process, so that the application knows the changes of the window.

The super taskbar operation in Step 103 comprises one or more of the following operations: creating a window thumbnail, creating a thumbnail toolbar, creating a window live preview, creating a taskbar button icon, and creating a taskbar overlay icon.

The operation of creating a window thumbnail comprises: when taskbar buttons are combined, scaling down the current drawing of the main panel of the IM software (hereinafter abbreviated to the main panel) onto a canvas to obtain a thumbnail; and when taskbar buttons are not combined, in an invisible window, placing a user portrait at a static image control, placing a user nickname and account at a static text control, and scaling down the user portrait, the user nickname and account, and the current drawing of the main panel onto a same canvas to obtain a thumbnail.

The operation of creating a thumbnail toolbar comprises: when a taskbar button creation message is detected, creating a thumbnail toolbar, for example, creating a thumbnail toolbar by using an ITaskbarList3 interface of Windows 7 in a Windows 7 operating system.

The operation of creating a window live preview comprises: outputting the current drawing of the main panel to obtain a preview.

The operation of creating a taskbar button icon comprises: when taskbar buttons are not combined, setting a taskbar button icon corresponding to the main panel to a user-defined portrait.

The operation of creating a taskbar overlay icon comprises: when only one user logs in currently, overlaying the online state of the user on a taskbar button icon corresponding to the user, for example, online, hidden, busy, or away, to generate a taskbar overlay icon; when multiple users log in currently and taskbar buttons are not combined, respectively overlaying the online state of the corresponding user on a taskbar button icon corresponding to each user to generate a taskbar overlay icon; and when multiple users log in currently and taskbar buttons are combined, not overlaying the online state of each user on a taskbar button icon.

When a locked state change, a panel size change, a panel hidden state change, or a panel position change, or any combination thereof occurs on the main panel, the operation of executing a super taskbar according to the detected window message in Step 103 while monitoring the window message further comprises: refreshing the window thumbnail.

In this case, the operation of creating a window live preview comprises: setting the size of the virtual window to be the same as the size of the main panel; and meanwhile processing a shift position of the preview as follows: when the main panel is not hidden, setting the shift position to a position difference between the virtual window and the main panel; when the main panel is hidden at an edge and is currently floating at a screen edge, setting the shift position to the position difference between the virtual window and the main panel; and when the main panel is hidden at an edge and is currently not floating at a screen edge, setting the shift position to the position difference between the virtual window and the main panel plus the size of the main panel.

The operation of creating a taskbar button icon comprises: converting a portrait file in a memory into a HICON format.

The operation of executing a super taskbar according to the detected window message while monitoring the window message further comprises: generating a jump list, and executing a corresponding jump operation according to a shortcut set for each item in the jump list.

When multiple accounts are logged in, the processes corresponding to the multiple accounts display current instant states of all the accounts in the jump list through a shared memory.

It should be noted that the super taskbar mentioned in the embodiment of the present invention is, but not limited to, the Windows 7 taskbar, and may refer to other taskbars having the functions of the Windows 7 taskbar, for example, a taskbar in an updated version of Windows 7, as may be easily thought of by those skilled in the art.

The second embodiment of the present invention provides a method for using a super taskbar to control IM software. In this embodiment, a rich variety of common controls are implemented for the IM software in areas such as the thumbnail of the super taskbar, thumbnail toolbar, taskbar button, taskbar overlay icon, and jump list; meanwhile, various operation and display entries of the super taskbar change with the number of accounts currently logging in to the machine, status of the accounts, related settings of the taskbar of the operating system, and so on.

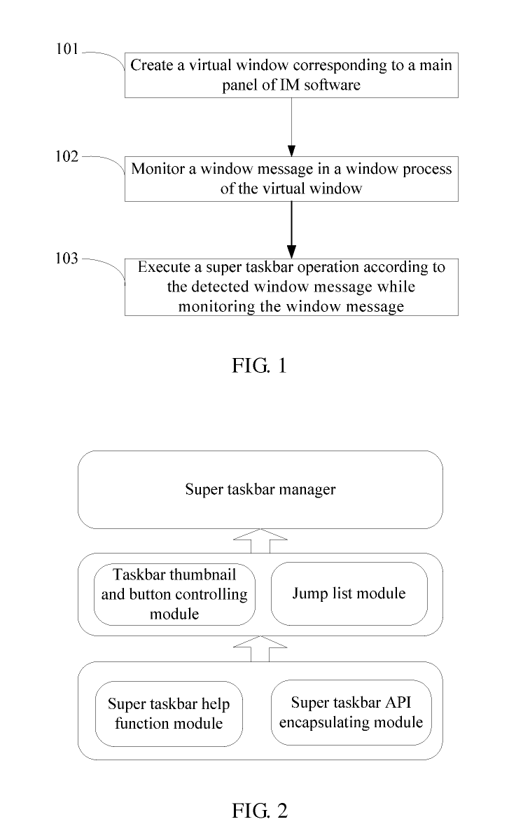

Specifically, the method provided by the second embodiment of the present invention is firstly described with reference to the technical hierarchical architecture of the IM software illustrated in FIG. 2. After a user logs in to the IM software, an “IM super taskbar manager” in the IM software creates a virtual window through a “taskbar thumbnail and button controlling module”, and controls the operation and display entries of the window thumbnail of the taskbar, thumbnail toolbar, window live preview, taskbar button icon, and taskbar overlay icon through the virtual window. Meanwhile, the “IM super taskbar manager” generates different jump lists according to different occasions through the “jump list module”. The “IM super taskbar manager” responds to the user's shortcut operation in the taskbar area and jump list to control the IM software. It should be noted that the “IM super taskbar manager”, “taskbar thumbnail and button controlling module”, and “jump list module” are all software codes corresponding to specific functions.

To explain the method for using a super taskbar to control IM software according to this embodiment, the following describes the function modules in FIG. 2 in detail.

After the user logs in to the IM software, the “IM super taskbar manager” of the IM software creates a virtual window, monitors window messages through the virtual window (for example, hovering of a mouse pointer over a taskbar icon), and executes six parts of operations according to the detected messages while monitoring the window message, namely, creating a window thumbnail of the taskbar, creating a thumbnail toolbar, creating a window live preview, creating a taskbar button icon, and creating a taskbar overlay icon.

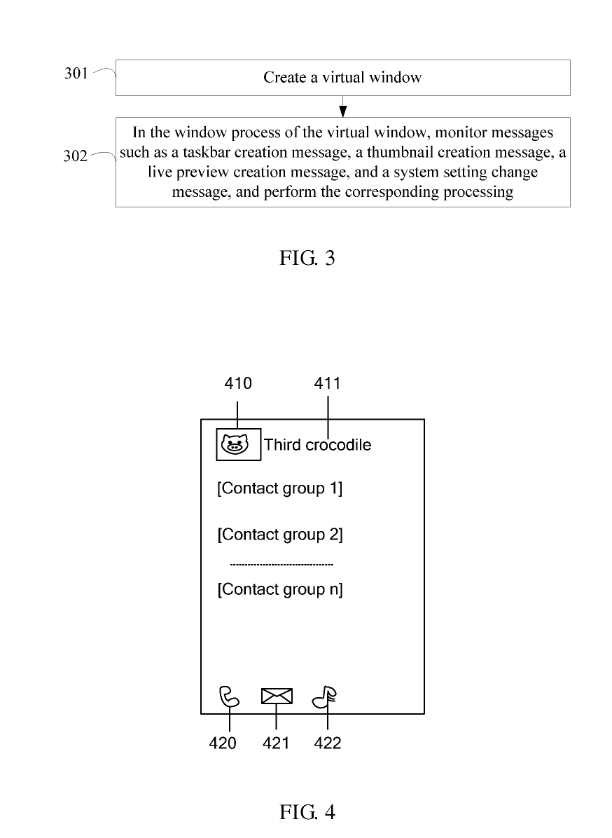

As shown in FIG. 3, controlling the representation of a main panel on a taskbar through a virtual window comprises:

Step 301: create a virtual window.

Specifically, the virtual window is created by the taskbar thumbnail and button controlling module. The created virtual window is set to be always visible and placed at any distance (for example, a distance that is 10 times the screen size), and the lifetime is consistent with that of the main panel.

Step 302: in the window process of the virtual window, monitor messages such as a taskbar creation message, a thumbnail creation message, a live preview creation message, and a system setting change message, and perform the corresponding processing.

The system setting change comprises the taskbar button combination mode, the number of recently accessed programs to be displayed on the “Start” menu, and so on.

It should be pointed out that using the virtual window to replace the main panel has the following advantages:

(1) The main panel in different periods corresponds to different windows, and may be a contact main panel or a locked panel. The virtual window may be used to manage the representations of multiple panels (windows) on the taskbar in a unified manner;

(2) The virtual window may be used to process the window messages of the operating system in a centralized manner, without changing the logic of the original main panel; and

(3) When the main panel is hidden, the virtual window may still be used to normally operate the main panel in the taskbar area.

The following describes how to use the virtual window to control the operations of the window thumbnail of the taskbar, thumbnail toolbar, window live preview, taskbar button icon, and taskbar overlay icon, and firstly describes how to use the virtual window to control the operation of the window thumbnail of the taskbar.

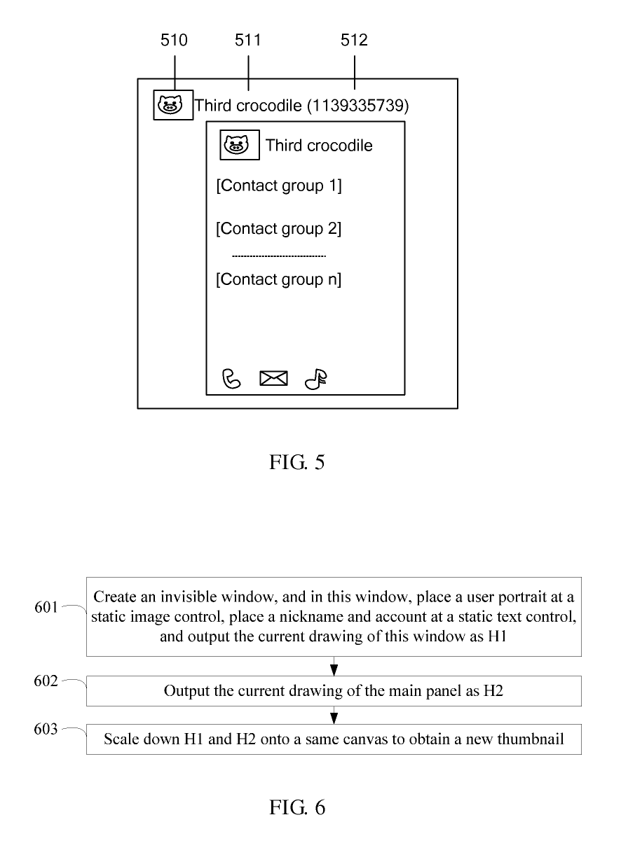

When taskbar buttons are combined (for example, taskbar buttons are combined when multiple users log in to the IM software), the window thumbnail is a thumbnail of the main panel. In this case, the current drawing of the main panel needs to be output, and scaled down onto a canvas to obtain a thumbnail. For example, the window thumbnail of a user as shown in FIG. 4, comprises a user portrait 410, a user nickname 411, contact groups, and function buttons 420 to 422. When taskbar buttons are not combined (for example, taskbar buttons are not combined when multiple users log in to the IM software or a single user logs in to the IM software), the window thumbnail is a combination of “user portrait plus nickname plus account” and the thumbnail of the main panel. For example, the window thumbnail of a user as shown in FIG. 5 comprises a portrait 510, a nickname 511, an account 512, and the window thumbnail illustrated in FIG. 4.

When taskbar buttons are not combined, the process of creating the thumbnail of the main panel, as shown in FIG. 6, comprises:

Step 601: create an invisible window, and in this window, place a user portrait at a static image control, place a nickname and account at a static text control, and output the current drawing of this window as H1;

Step 602: output the current drawing of the main panel as H2; and

Step 603: scale down H1 and H2 onto a same canvas to obtain a new thumbnail.

It should be noted that when one or more preset changes occur on the main panel, the system is forced to refresh the thumbnail. The one or more preset changes comprise a locked state change, a panel size change, a panel hidden state change, and a panel position change. To maintain the correctness of the thumbnail of the main panel and the live preview, and to avoid frequent refreshing, the system is forced to refresh the thumbnail when one of the preceding changes occurs on the main panel.

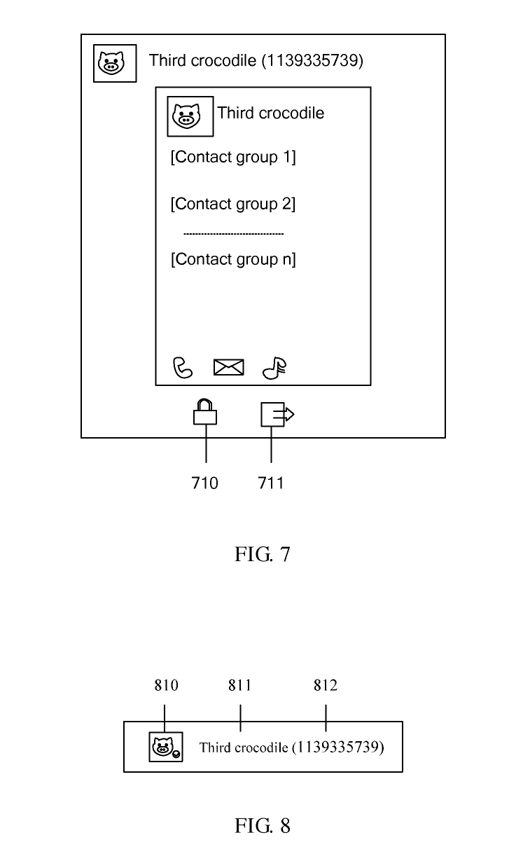

When a thumbnail toolbar is created, buttons may be customized on the thumbnail toolbar according to actual requirements. For example, as shown in FIG. 7, the thumbnail toolbar supports a “Lock/Unlock IM” button 710 and an “Exit” button 711. In the embodiment of the present invention, when a corresponding thumbnail toolbar creation message is detected through the virtual window, a thumbnail toolbar is created (for example, the ITaskbarList3 interface in the Windows 7 operating system is used to create a thumbnail toolbar), and a “Lock/Unlock IM” button and an “Exit” button are placed on the thumbnail toolbar. Herein, a button ID needs to be set in order to monitor a button click message. When the locked state changes, an icon for locking or unlocking IM is correspondingly set for the first button.

A window live preview is created on a program-defined basis. For example, during the creation of a window live preview, the current drawing of the main panel may be output directly to obtain a preview. The window live preview keeps consistent with the system default. This preview is created on a program-defined basis and may be extended according to subsequent actual applications. The default position and default size of the window live preview are consistent with those of a real window. Therefore, before the preview is displayed, the size of the virtual window is set to be consistent with the size of the main panel. In addition, the shift position of the preview needs to be processed. Specifically, when the main panel is not hidden, the shift position is set to a position difference between the virtual window and the main panel; when the main panel is hidden at an edge and is currently floating at a screen edge, for example, the mouse pointer moves to the bottom of the main panel, the shift position is set to the position difference between the virtual window and the main panel; and when the main panel is hidden at an edge and is currently not floating at a screen edge, the shift position is set to the position difference between the virtual window and the main panel plus the size (height or width) of the main panel.

The creation of a taskbar button icon involves two cases: taskbar buttons are combined, and taskbar buttons are not combined. For the latter, the taskbar button icon corresponding to the main panel is set to a user-defined portrait, for example, a user-defined portrait 810 shown in FIG. 8. Specifically, it is only necessary to convert the title icon of the virtual window into a user-defined portrait. The portrait file in the memory is converted into the HICON format. Meanwhile, the title of the taskbar button is set to a combination of a user nickname 811 and an account 812.

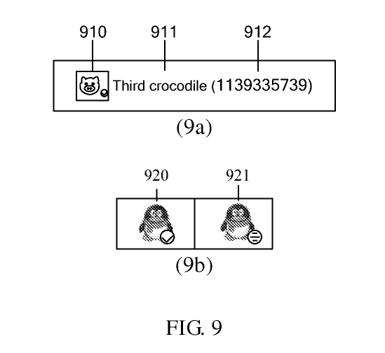

According to the current state of the user, a state icon is overlaid on the taskbar button. The state comprises the online state and locked state. It should be noted that when the state icon is overlaid on the taskbar button, the processing varies according to the taskbar button combination state and the number of accounts simultaneously logged in on the machine: When only one account is logged in, regardless of whether the taskbar buttons are combined or not, a state icon is overlaid on the taskbar button, as shown in FIG. 9a, and comprises a user-defined portrait 910 in the online state, a nickname 911, and an account 912. When multiple accounts are logged in and taskbar buttons are not combined, a state icon is overlaid on the taskbar button, as shown in FIG. 9b, which respectively illustrates a program icon 920 displaying the online state and a program icon 921 displaying the hidden state. When multiple accounts are logged in and taskbar buttons are combined, only the program icon is displayed, and the state is not displayed. The taskbar button combination state is obtained by reading the registry. When the user changes the combination option dynamically, the taskbar button combination state may be obtained through a response window message.

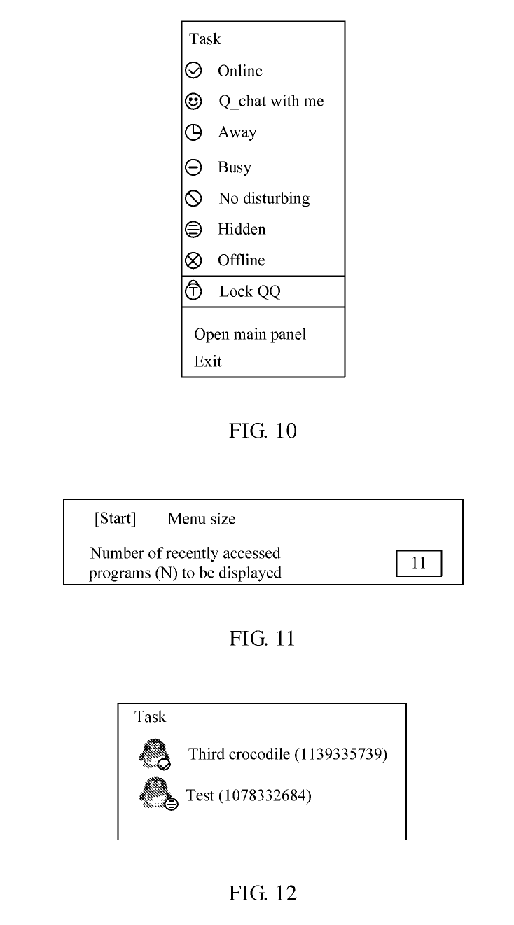

The following describes a process of creating a jump list through the jump list module in the embodiment of the present invention. In this process, different processing is needed according to the number of accounts simultaneously logged in: when only one account is logged in, the jump list comprises shortcuts for setting the user online state, locking IM, opening the main panel, and exiting, as shown in FIG. 10. Because the system limits the height of the jump list according to the current setting, during the creation of the jump list, it is necessary to first dynamically judge the number of recently accessed programs (N) to be displayed on the “Start” menu, for example, as shown in FIG. 11, N is 11. If N can contain all current user-defined states, the user-defined states are added to the jump list; otherwise, the user-defined states are not added to the jump list. When multiple accounts are logged in, the jump list comprises an information list of all accounts currently logged in. When the information list is clicked on, the corresponding main panel is displayed. As shown in FIG. 12, each user information list comprises a state-overlaid program icon plus nickname plus account.

To implement the jump function of the jump list, each item in the jump list is set to a shortcut. Preferably, the format is an application program plus some parameters. In the present invention, an application program APP is specially designed to communicate with the IM tool and transfer the parameters of the shortcut to the IM tool, so that the IM tool executes a corresponding jump operation according to the obtained parameters and the configured application. The format of the shortcut is defined as: APP Uin CmdID Param GUID.

The specific meaning of each parameter in the above format of the shortcut is as follows:

Uin: user account;

CmdID: command ID, which indicates an operation type, comprising displaying an IM client, various online states, locking IM, unlocking IM, opening the main panel, exiting, and so on.

Param: user-defined state name; and

GUID: a unique ID, which is included when the jump list is created and is updated every time when the jump list is re-created.

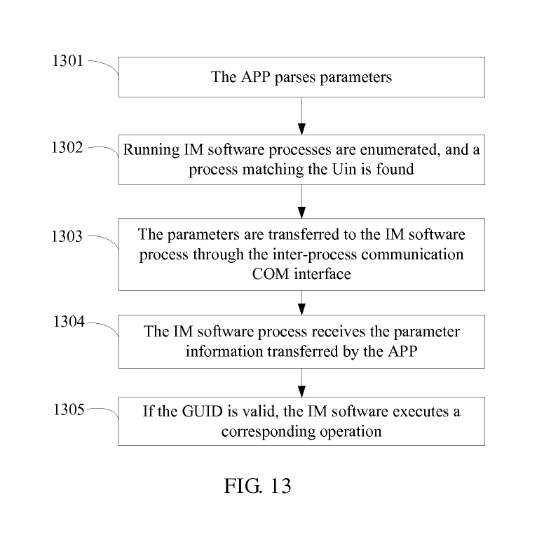

When the shortcut is clicked, the APP corresponding to the shortcut is started, and then the parameters “Uin”, “CmdID”, “Param”, and “GUID” are transferred to the APP. After parsing the parameters, the APP transfers the parameters to the IM tool to control the IM tool. The shortcut is executed through the coordination between the APP and the IM tool. As shown in FIG. 13, the process specifically comprises:

Step 1301: the APP parses parameters;

Step 1302: running IM software processes are enumerated, and a process matching the Uin is found;

Step 1303: the parameters are transferred to the IM software process through the inter-process communication COM interface;

Step 1304: the IM software process receives the parameter information transferred by the APP; and

Step 1305: if the GUID is valid, the IM software executes a corresponding operation.

When multiple accounts are logged in, the system needs to display the current instant states of all the accounts. However, in the prior art, because different accounts are unable to know the instant states of each other, including the online state and locked state, the current instant states of all the accounts cannot be displayed. In the present invention, the IM software processes corresponding to different accounts share information through a shared memory, and the processes corresponding to the accounts maintain respective instant states in the shared memory. When the state of an account is updated, the corresponding process needs to update the jump list, and the state information therein is obtained from the shared memory.

The representation of the taskbar overlay icon and the jump list varies according to the number of accounts currently logged in, and such changes are instant. The taskbar overlay icon also uses the COM interface to implement inter-process communication, similar to the execution of a shortcut in the jump list. The difference is that the communication occurs between two existing IM software processes and that there is no need to additionally start a third-party process.

When an account is logged in or out, the account sends a notification to other account. Then the IM software processes corresponding to this account and other accounts update the taskbar overlay icon or jump list according to the actual conditions.

The following describes the super taskbar help function module and the super taskbar API encapsulating module. The super taskbar help function module provides some common functions: obtaining the path to the current state icon, generating a thumbnail, obtaining the current settings about the taskbar of the system, and so on. The super taskbar API encapsulating module encapsulates the SDK API of the operating system to provide a simple and easy-to-use interface.

The method provided by the present invention is capable of creating a virtual window corresponding to a main panel of IM software, monitoring a window message in a window process of the virtual window, and executing a super taskbar operation according to the detected window message while monitoring the window message, so that the IM software supports the super taskbar, that is, the running state of the IM software is controlled by using the super taskbar, thus greatly improving a user's experience in using the IM software.

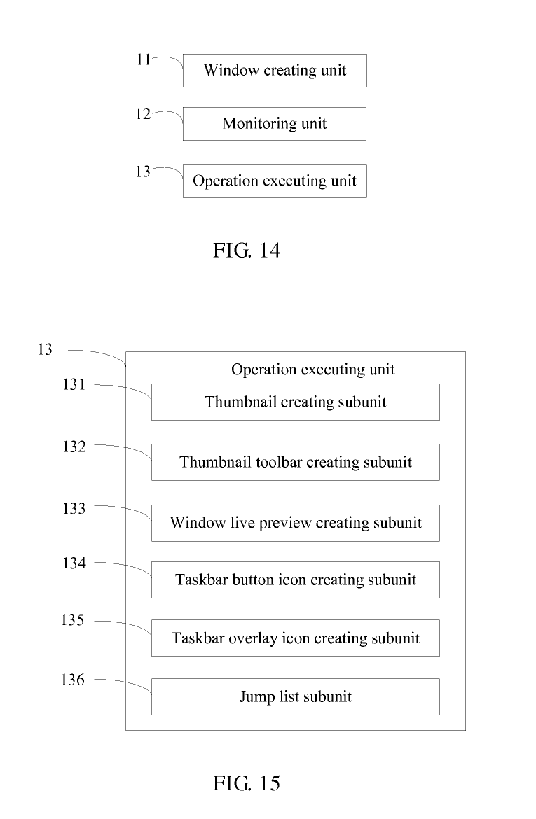

The third embodiment of the present invention provides a device for using a super taskbar to control IM software. As shown in FIG. 14, the device comprises:

a window creating unit 11, configured to create a virtual window corresponding to a main panel of the IM software;

a monitoring unit 12, configured to monitor a window message in a window process of the virtual window created by the window creating unit 11; and

an operation executing unit 13, configured to execute a super taskbar operation according to the window message detected by the monitoring unit 12 while monitoring the window message.

The super taskbar operation comprises one or more of the following operations: creating a window thumbnail, creating a thumbnail toolbar, creating a window live preview, creating a taskbar button icon, and creating a taskbar overlay icon.

As shown in FIG. 15, the operation executing unit 13 comprises:

a thumbnail creating subunit 131, configured to: when taskbar buttons are combined, scale down the current drawing of the main panel onto a canvas to obtain a thumbnail; and when taskbar buttons are not combined, in an invisible window, place a user portrait at a static image control, place a user nickname and account at a static text control, and scale down the user portrait, the user nickname and account, and the current drawing of the main panel onto a same canvas to obtain a thumbnail; and/or

a thumbnail toolbar creating subunit 132, configured to create a thumbnail toolbar when a taskbar button creation message is detected; and/or

a window live preview creating subunit 133, configured to output the current drawing of the main panel to obtain a preview; and/or

a taskbar button icon creating subunit 134, configured to: when taskbar buttons are not combined, set a taskbar button icon corresponding to the main panel to a user-defined portrait; and/or

a taskbar overlay icon creating subunit 135, configured to: when only one user logs in currently, overlay a state icon on a taskbar button; when multiple users log in currently and taskbar buttons are not combined, overlay a state icon on a taskbar button; and when multiple users log in currently and taskbar buttons are combined, not overlay a state icon on a taskbar button.

The thumbnail creating subunit 131 is further configured to: when a locked state change, a panel size change, a panel hidden state change, or a panel position change, or any combination thereof occurs on the main panel, refresh the window thumbnail.

The window live preview creating subunit 133 is further configured to set the size of the virtual window to be the same as the size of the main panel; and meanwhile process a shift position of the preview as follows: when the main panel is not hidden, set the shift position to a position difference between the virtual window and the main panel; when the main panel is hidden at an edge and is currently floating at a screen edge, set the shift position to the position difference between the virtual window and the main panel; and when the main panel is hidden at an edge and is currently not floating at a screen edge, set the shift position to the position difference between the virtual window and the main panel plus the size of the main panel.

The taskbar button icon creating subunit 134 is further configured to convert a portrait file in a memory into a HICON format.

The operation executing unit 13 further comprises:

a jump list subunit 136, configured to generate a jump list according to the detected window message, and execute a corresponding jump operation according to a shortcut set for each item in the jump list.

The jump list subunit 136 is further configured to: when multiple accounts are logged in, display current instant states of all the accounts in the jump list through a process shared memory corresponding to the processes of the multiple accounts.

The device provided by the present invention is capable of creating a virtual window corresponding to a main panel of IM software, monitoring a window message in a window process of the virtual window, and executing a super taskbar operation according to the detected window message, so that the IM software supports the super taskbar, that is, the running state of the IM software is controlled by using the super taskbar, thus greatly improving a user's experience in using the IM software.

According to the description of the embodiments, those skilled in the art understand that the present invention may be implemented by software in addition to a hardware platform or by hardware only. In most circumstances, the former is preferred. The technical solutions of the present invention, or the portions contributing to the prior art can be embodied in the form of a software product. The computer software product is stored in a storage medium, such as a computer floppy disk, a hard disk, or a CD-ROM, comprising several instructions to cause a computer device (which may be a personal computer, a server, or a network device) to execute the method described in each embodiment of the present invention. Or a universal hardware device is configured as the device of the present invention to implement the solutions described in the embodiments of the present invention. The universal hardware device comprises a memory, such as a ROM/RAM, configured to store instructions; and a processor, such as a CPU, coupled with the memory, and configured to execute the instructions stored in the memory.

Those skilled in the art understand that the accompanying drawings illustrate the preferred embodiments of the present invention and that the modules or procedures in the accompanying drawings may be not necessary for the implementation of the present invention.

Those skilled in the art can understand the modules of the devices in the embodiments may be disposed in the devices as described in the embodiments or disposed in one or more devices other than the devices in the embodiments. The modules according to the above embodiments may be combined into one module, or split into multiple submodules.

The sequence numbers of the above embodiments of the present invention are only for ease of description, and do not denote the preference of the embodiments.

Only exemplary embodiments of the present invention are disclosed above, but the present invention is not limited thereto. Modifications and variations readily apparent to those skilled in the art shall fall within the scope of the present invention.

What is claimed is:

1. A method for using a super taskbar to control instant messaging (IM) application, comprising:
creating a virtual window corresponding to a main panel of the IM application;
monitoring a window message in a window process of the virtual window; and
executing a super taskbar operation according to the detected window message while monitoring the window message.

2. The method according to claim 1, wherein the super taskbar operation comprises one or more of the following operations:
creating a window thumbnail, creating a thumbnail toolbar, creating a window live preview, creating a taskbar button icon, or creating a taskbar overlay icon.

3. The method according to claim 2, wherein:
the operation of creating a window thumbnail comprises: when taskbar buttons are combined, scaling down a current drawing of the main panel onto a canvas to obtain a thumbnail; when taskbar buttons are not combined, in an invisible window, placing a user portrait at a static image control, placing a user nickname and account at a static text control, and scaling down the user portrait, the user nickname and account, and the current drawing of the main panel onto a same canvas to obtain a thumbnail;
the operation of creating a thumbnail toolbar comprises: when a taskbar button creation message is detected, creating a thumbnail toolbar;
the operation of creating a window live preview comprises: outputting the current drawing of the main panel to obtain a preview;
the operation of creating a taskbar button icon comprises: when taskbar buttons are not combined, setting a taskbar button icon corresponding to the main panel to a user-defined portrait; and
the operation of creating a taskbar overlay icon comprises: when only one user logs in, overlaying an online state of the user on a taskbar button icon corresponding to the user to generate a taskbar overlay icon; when multiple users log in and taskbar buttons are not combined, respectively overlaying an online state of the corresponding user on a taskbar button icon corresponding to each user to generate a taskbar overlay icon; and when multiple users log in and taskbar buttons are combined, not overlaying an online state of each user on a taskbar button icon.

4. The method according to claim 3, wherein: the executing a super taskbar operation according to the detected window message while monitoring the window message further comprises: when a locked state change, a panel size change, a panel hidden state change, or a panel position change, or any combination thereof occurs on the main panel, refreshing the window thumbnail;
the operation of creating a window live preview comprises: setting the size of the virtual window to be the same as the size of the main panel; and processing a shift position of the preview according to at least one of following operations: when the main panel is not hidden, setting the shift position to a position with a difference between the virtual window and the main panel; when the main panel is hidden at an edge and is currently floating at a screen edge, setting the shift position to a position with a difference between the virtual window and the main panel; and when the main panel is hidden at an edge and is currently not floating at a screen edge, setting the shift position to a position with a difference between the virtual window and the main panel plus the size of the main panel; and
the operation of creating a taskbar button icon comprises: converting a portrait file in a memory into a HICON format.

5. The method according to claim 1, wherein the executing a super taskbar operation according to the detected window message while monitoring the window message further comprises:
generating a jump list, and executing a corresponding jump operation according to a shortcut set for each item in the jump list.

6. The method according to claim 5, wherein a format of the shortcut is an application plus one or more parameters, the application communicates with the IM application to transfer the one or more parameters of the shortcut to the IM application, so that the IM application executes the corresponding jump operation according to the one or more parameters and the application.

7. The method according to claim 6, wherein the communicating, by the application, with the IM application to transfer the one or more parameters of the shortcut to the IM application comprises:
when the shortcut is clicked, starting the application corresponding to the shortcut, then transferring the one or more parameters to the application, and after the application parses each of the one or more parameters, transferring the one or more parameters to the IM application.

8. The method according to claim 5, wherein, when multiple users log in, processes corresponding to the multiple users display current instant states of all the multiple users in the jump list through a shared memory.

9. The method according to claim 8, wherein respective process corresponding to each of the multiple users maintains its instant state in the shared memory.

10. The method according to claim 8, wherein, when one of the multiple users logs in or exits, the one of the multiple users sends a notification to other users, and IM application processes corresponding to the one of the multiple users and other users all update respective taskbar overlay icon or respective jump list.

11. A device for using a super taskbar to control instant messaging (IM) application, comprising: a memory, configured to store instructions; and a processor, coupled with the memory, configured to execute the instructions stored in the memory, and further configured to:
create a virtual window corresponding to a main panel of the IM application;
monitor a window message in a window process of the virtual window; and
execute a super taskbar operation according to the detected window message while monitoring the window message.

12. The device according to claim 11, wherein the super taskbar operation comprises one or more of the following operations:
creating a window thumbnail, creating a thumbnail toolbar, creating a window live preview, creating a taskbar button icon, or creating a taskbar overlay icon.

13. The device according to claim 12, wherein:
the operation of creating a window thumbnail comprises: when taskbar buttons are combined, scaling down a current drawing of the main panel onto a canvas to obtain a thumbnail; and when taskbar buttons are not combined, in an invisible window, placing a user portrait at a static image control, placing a user nickname and account at a static text control, and scaling down the user portrait, the user nickname and account, and the current drawing of the main panel onto a same canvas to obtain a thumbnail;
the operation of creating a thumbnail toolbar comprises: when a taskbar button creation message is detected, creating a thumbnail toolbar;
the operation of creating a window live preview comprises: outputting the current drawing of the main panel to obtain a preview;
the operation of creating a taskbar button icon comprises: when taskbar buttons are not combined, setting a taskbar button icon corresponding to the main panel to a user-defined portrait; and
the operation of creating a taskbar overlay icon comprises: when only one user logs in currently, overlaying an online state of the user on a taskbar button icon corresponding to the user to generate a taskbar overlay icon; when multiple users log in currently and taskbar buttons are not combined, respectively overlaying an online state of the corresponding user on a taskbar button icon corresponding to each user to generate a taskbar overlay icon; and when multiple users log in currently and taskbar buttons are combined, not overlaying an online state of each user on a taskbar button icon.

14. The device according to claim 13, wherein: the executing a super taskbar operation according to the detected window message while monitoring the window message further comprises: when a locked state change, a panel size change, a panel hidden state change, or a panel position change, or any combination thereof occurs on the main panel, refreshing the window thumbnail;
the operation of creating a window live preview comprises: setting the size of the virtual window to be the same as the size of the main panel; processing a shift position of the preview according to at least one of following operations: when the main panel is not hidden, setting the shift position to a position with a difference between the virtual window and the main panel; when the main panel is hidden at an edge and is currently floating at a screen edge, setting the shift position to a position with a difference between the virtual window and the main panel; and when the main panel is hidden at an edge and is currently not floating at a screen edge, setting the shift position to a position with a difference between the virtual window and the main panel plus the size of the main panel; and
the operation of creating a taskbar button icon comprises: converting a portrait file in a memory into a HICON format.

15. The device according to claim 11, wherein the executing a super taskbar operation according to the detected window message while monitoring the window message further comprises:
generating a jump list, and executing a corresponding jump operation according to a shortcut set for each item in the jump list.

16. The device according to claim 15, wherein a format of the shortcut is an application plus one or more parameters, wherein the application communicates with the IM application to transfer the one or more parameters of the shortcut to the IM application, so that the IM application executes the corresponding jump operation according to the one or more obtained parameters and the application.

17. The device according to claim 16, wherein the communicating, by the application, with the IM application to transfer the one or more parameters of the shortcut to the IM application comprises:
when the shortcut is clicked, starting the application corresponding to the shortcut, then transferring the one or more parameters to the application, and after the application parses each of the parameters, transferring the parameters to the IM software.

18. The device according to claim 15, wherein, when multiple users log in, processes corresponding to the multiple users display current instant states of all the users in the jump list through a shared memory.

19. The device according to claim 18, wherein respective process corresponding to each of the multiple users maintains its instant state in the shared memory; and when one of the multiple users logs in or exits, the one of the multiple users sends a notification to other users, and IM application processes corresponding to the one of the multiple users and other users all update respective taskbar overlay icon or respective jump list.

20. A machine-readable medium storing an instruction set, wherein, when the instruction set is executed, the machine is enabled to execute a method for using a super taskbar to control instant messaging (IM) application, wherein the method comprises:
creating a virtual window corresponding to a main panel of the IM application;
monitoring a window message in a window process of the virtual window; and
executing a super taskbar operation according to the detected window message while monitoring the window message.
